(19) United States
(12) Patent Application Publication
(10) Pub. No.: US 2019/0066023 A1
(43) Pub. Date: Feb. 28, 2019

(54) DEVICES AND METHODS FOR GENERATING, MAINTAINING, AND PROVIDING A COGNITIVE CAREER PROFILE AND ASSOCIATED CAREER DATA

(71) Applicant: salesforce.com, inc., San Francisco, CA (US)

(72) Inventors: KATHERINE IDZELIS VON JAN, PLEASANTVILLE, NY (US); ITAI ASSEO, MOUNT KISCO, NY (US)

(73) Assignee: salesforce.com, inc., San Francisco, CA (US)

(21) Appl. No.: 15/692,362

(22) Filed: Aug. 31, 2017

(51) Int. Cl. G06Q 10/06; G06F 17/30; H04L 12/24

(52) U.S. Cl. CPC G06Q 10/06398; G06F 17/30702; G06Q 10/10; H04L 41/12; G06Q 10/06

(57) ABSTRACT

A method for providing career data by a computer system is provided. The method obtains employee profile data to create an employee profile for an enterprise software application platform, wherein the employee profile data comprises at least qualifications, skills, competencies, and experience level of a particular employee, and wherein the employee profile is shared by one or more applications (apps) associated with the enterprise software application platform; obtains employer organizational data from an employer database associated with the enterprise software application platform, the employer organizational data comprising at least employee roles and employee projects associated with an employer; identifies action items for the particular employee, based on the employee profile data and the employer organizational data; and transmits the action items, the action items comprising recommendations for the particular employee.

### TECHNICAL FIELD

Embodiments of the subject matter described herein relate generally to creating and maintaining employee data profiles. More particularly, embodiments of the subject matter relate to dynamically creating an updated career profile, and providing career recommendations in real-time, based on the dynamically updated career profile.

### BACKGROUND

Generally, when the employee joins a company, an employer will create a simple version of an employee profile (e.g., an employment record or employment file). This simple profile includes data gathered by the company based on direct interactions with the employee, such as recruitment data, data acquired during the hiring process, or the like. The simple profile may be created by the company for internal use only, and usually remains with the company or is destroyed when the employee no longer works for that particular company. A new employee profile or employee file must be created when the employee obtains new employment at a different company. In this situation, the details associated with the employee and stored in the original employee profile are unavailable to the employee or the new company. Thus, employment opportunities and promotions sought or offered, mentoring, advising, and other employment-related decision-making are often performed based on incomplete career, educational, and personal development-related information.

Accordingly, it is desirable to provide continuity and a more complete and contextual picture of an employee when career and educational decisions are made. Furthermore, other desirable features and characteristics will become apparent from the subsequent detailed description and the appended claims, taken in conjunction with the accompanying drawings and the foregoing technical field and background.

### BRIEF SUMMARY

Some embodiments of the present disclosure provide a method for providing career data by a computer system comprising at least a processor and a system memory element. The method obtains employee profile data to create an employee profile for an enterprise software application platform, by the processor, wherein the employee profile data comprises at least qualifications, skills, competencies, and experience level of a particular employee, and wherein the employee profile is shared by one or more applications (apps) associated with the enterprise software application platform; obtains employer organizational data from an employer database associated with the enterprise software application platform, by the processor, the employer organizational data comprising at least employee roles and employee projects associated with an employer; identifies action items for the particular employee, by the processor, based on the employee profile data and the employer organizational data; and transmits the action items, by a communication device communicatively coupled to the processor, the action items comprising recommendations for the particular employee.

Some embodiments of the present disclosure provide a computer system that includes: a system memory element; a communication device configured to establish a communication connection to a second computer system and to transmit career data for a particular employee; and at least one processor communicatively coupled to the system memory element and the communication device, the at least one processor configured to: obtain employee profile data to create an employee profile for an enterprise software application platform, by the processor, wherein the employee profile data comprises at least qualifications, skills, competencies, and experience level of a particular employee, and wherein the employee profile is shared by one or more applications (apps) associated with the enterprise software application platform; obtain employer organizational data from an employer database associated with the enterprise software application platform, by the processor, the employer organizational data comprising at least employee roles and employee projects associated with an employer; identify action items for the particular employee, by the processor, based on the employee profile data and the employer organizational data; and transmit the action items, by a communication device communicatively coupled to the processor, the action items comprising recommendations for the particular employee.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a diagram of a system for providing career data customized to a particular employee, in accordance with the disclosed embodiments;

FIG. 2 is a functional block diagram of an employer computer system, in accordance with the disclosed embodiments;

FIG. 3 is a functional block diagram of an employee computing device, in accordance with the disclosed embodiments;

FIG. 4 is a diagram of a computer architecture for producing a cognitive employee profile, in accordance with the disclosed embodiments;

FIG. 5 is a flow chart that illustrates an embodiment of a process for providing career data by a computer system comprising at least a processor and a system memory element, in accordance with the disclosed embodiments;

FIG. 6 is a flow chart that illustrates an embodiment of a process for obtaining employee profile data, in accordance with the disclosed embodiments;

FIG. 7 is a flow chart that illustrates an embodiment of a process for identifying the action items for a particular employee;

FIG. 8 is a flow chart that illustrates another embodiment of a process for identifying the action items for a particular employee; and

FIG. 9 is a conceptual block diagram of a multi-tenant system in accordance with the disclosed embodiments.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

The subject matter presented herein relates to devices, systems, and methods for creating and using a comprehensive, cognitive employee profile to provide actionable career improvement and personal development advice throughout the course of a career. In certain embodiments, the cognitive employee profile may be an internal data entity that is accessible by and used for one particular company or organization. In some embodiments, the cognitive employee profile may be a portable data entity that is used by the particular employee throughout his career, wherein the profile is external to any particular employer or organization.

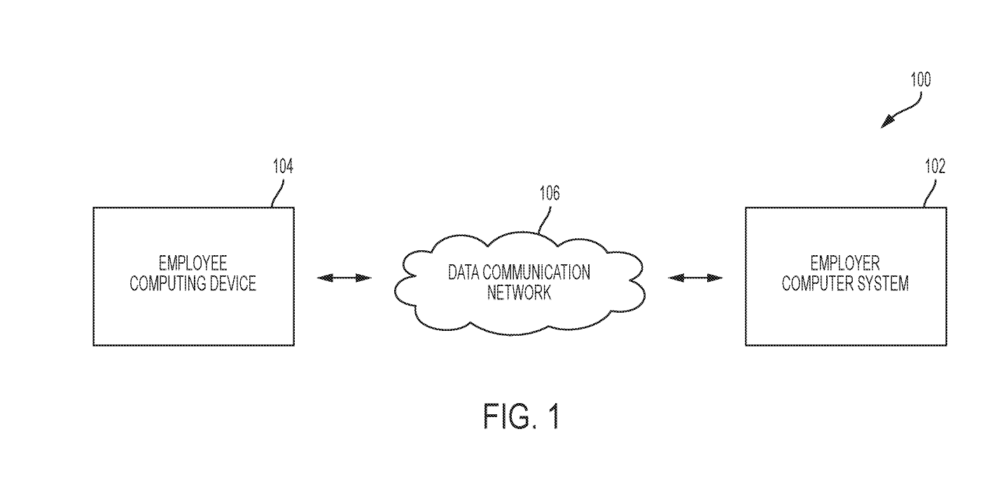

Turning now to the figures, FIG. 1 is a diagram of a system 100 for providing career data customized to a particular employee, in accordance with the disclosed embodiments. The system 100 operates to provide customized career recommendation data to a particular employee or other type of user seeking career and/or personal development advice. The system 100 is configured to provide actionable suggestions for the particular employee or user to follow in order to progress in his career. In the embodiment shown, the system 100 may include, without limitation, an employer computer system 102 that communicates with an employee computing device 104, via a data communication network 106, to provide career recommendation data. In practice, certain embodiments of the system 100 may include additional or alternative elements and components, as desired for the particular application.

The employer computer system 102 may be implemented by any computer or server system that includes at least one processor, some form of memory hardware, a display device, and input/output (I/O) hardware and software. The employer computer system 102 may be operated by one particular employer, organization, or company. In some embodiments, however, the employer computer system 102 may be operated by an external consultant or consultant organization that works with multiple employers, organizations, or companies. The employer computer system 102 is a “main” computer system that obtains employee-specific information and provides career progression recommendations, educational development recommendations, and personal development recommendations that are specific to the user.

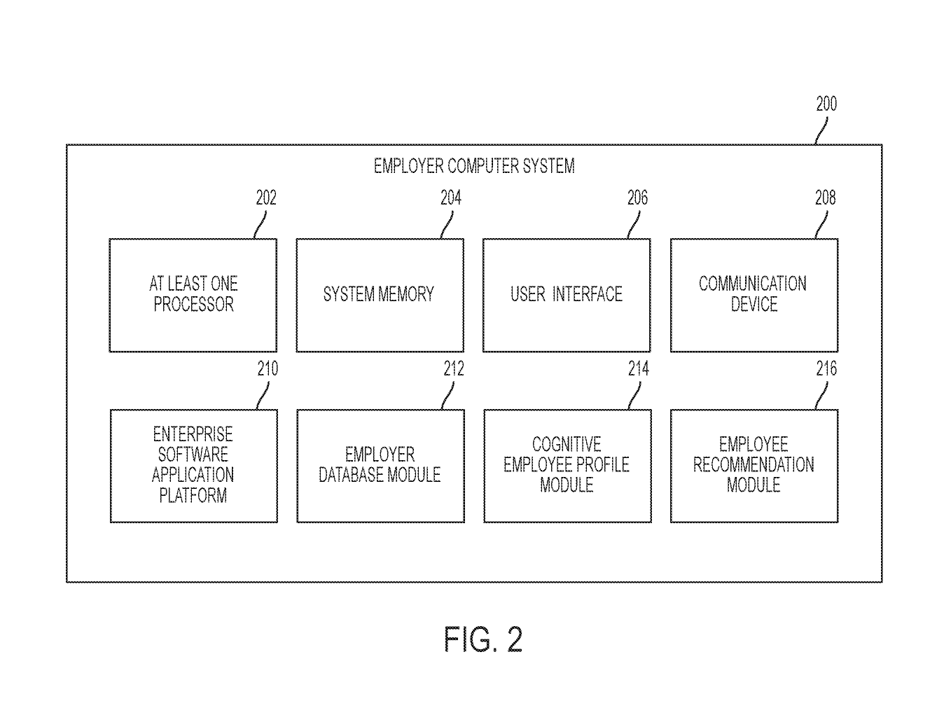

The employer computer system 102 stores, maintains, and operates an enterprise software application platform (as described herein with regard to FIG. 2). Enterprise software applications used in an organizational environment may include a vast array of data and tools and other features for interactions within a group of users and interactions with one or more databases. Such software applications are useful in an organization that includes a large number of users. As described herein, the enterprise software application platform may include, without limitation: one or more downloadable and customizable software applications (i.e., “apps”), social media elements, a human resources database, and communication interfaces for one or more apps that are external to the enterprise software application platform and online data sources external to the enterprise software application platform (e.g., professional networking sites, online learning sites).

The employee computing device 104 may be implemented by any computing device that includes at least one processor, some form of memory hardware, a user interface, a display device, and communication hardware. Exemplary embodiments of the employee computing device 104 may include, without limitation, a desktop computer, a laptop computer, a tablet computer, a smartphone, a smart-watch, a personal digital assistant (PDA), or the like. The employee computing device 104 is configured to interact with the employer computer system 102 via the enterprise software application platform. It should be appreciated that FIG. 1 depicts a simplified embodiment of the system 100, and that some implementations of the system 100 may include additional elements or components. For example, the employer computer system 102 may be implemented by one or more computer systems and/or server systems that are communicatively coupled via hardwired or wireless communication connections.

The employee computing device 104 communicates with the employer computer system 102 using wired and/or wireless communication connections, via the data communication network 106. The data communication network 106 may be any digital or other communications network capable of transmitting messages or data between devices, systems, or components. In certain embodiments, the data communication network 106 includes a packet switched network that facilitates packet-based data communication, addressing, and data routing. The packet switched network could be, for example, a wide area network, the Internet, or the like. In various embodiments, the data communication network 106 includes any number of public or private data connections, links or network connections supporting any number of communications protocols. The data communication network 106 may include the Internet, for example, or any other network based upon TCP/IP or other conventional protocols. In various embodiments, the data communication network 106 could also incorporate a wireless and/or wired telephone network, such as a cellular communications network for communicating with mobile phones, personal digital assistants, and/or the like. The data communication network 106 may also incorporate any sort of wireless or wired local and/or personal area networks, such as one or more IEEE 802.3, IEEE 802.16, and/or IEEE 802.11 networks, and/or networks that implement a short range (e.g., Bluetooth) protocol. For the sake of brevity, conventional techniques related to data transmission, signaling, network control, and other functional aspects of the systems (and the individual operating components of the systems) may not be described in detail herein.

During typical operation, the employer computer system 102 receives, collects, or otherwise obtains employee profile data associated with one particular employee to create a cognitive employee profile. The employee profile data may include any data associated with the employee's job performance, qualifications, skills, and competencies; any data acquired during the recruiting and/or hiring process; online professional networking sites used by the employee; data associated with an employee's online learning activities; user-entered employee profile data; data that the employee has entered into the social media elements of the enterprise software application platform; or the like.

The cognitive employee profile is a dynamically updated record associated with the particular employee, that is updated in real-time and maintained by the employer computer system 102 for the particular employee. The cognitive employee profile may be: (i) an internal cognitive employee profile, or (ii) an external, portable cognitive employee profile. The cognitive employee profile (maintained by the employer computer system 102) may be an internal cognitive employee profile, which is used by one organization. In this scenario, the cognitive employee profile is created when employee begins working with the organization or employer, and includes details specific to employment, hiring, and recruiting by the particular organization. In other embodiments, the cognitive employee profile may be an external, portable cognitive employee profile that the employee retains and continuously updates during the course of a career, regardless of employment with one particular organization. In this scenario, the cognitive employee profile may be created at any point in the employee's career (ideally at the beginning of the employee's career), and the cognitive employee profile is dynamically and continuously updated with career development, educational development, and personal development activities, certifications, and accomplishments.

Generally, the employer computer system 102 creates the cognitive employee profile, and continually updates the cognitive employee profile throughout the course of employment with a particular employer or organization, or throughout the course of a career. The employer computer system 102 obtains updated employee profile data in real-time, and completes updates to the cognitive employee profile based on the updated employee profile data. The employer computer system 102 uses the cognitive employee profile to determine potential action items for the employee to facilitate progression in career, education, or personal development. The employer computer system 102 transmits the cognitive employee profile and the potential action items (i.e., recommendations) to the employee computing device 104.

FIG. 2 is a functional block diagram of an employer computer system 200, in accordance with the disclosed embodiments. It should be noted that the employer computer system 200 can be implemented with the employer computer system 102 depicted in FIG. 1. In this regard, the employer computer system 200 shows certain elements and components of the employer computer system 102 in more detail. The employer computer system 200 generally includes, stores, maintains, operates, and/or executes, without limitation: at least one processor 202; system memory 204 hardware; a user interface 206; a communication device 208; an enterprise software application platform 210; an employer database module 212; a cognitive employee profile module 214; and an employee recommendation module 216. These elements and features of the employer computer system 200 may be operatively associated with one another, coupled to one another, or otherwise configured to cooperate with one another as needed to support the desired functionality, as described herein. For ease of illustration and clarity, the various physical, electrical, and logical couplings and interconnections for these elements and features are not depicted in FIG. 2. Moreover, it should be appreciated that embodiments of the employer computer system 200 will include other elements, modules, and features that cooperate to support the desired functionality. For simplicity, FIG. 2 only depicts certain elements that relate to the techniques described in more detail below.

The at least one processor 202 may be implemented or performed with one or more general purpose processors, a content addressable memory, a digital signal processor, an application specific integrated circuit, a field programmable gate array, any suitable programmable logic device, discrete gate or transistor logic, discrete hardware components, or any combination designed to perform the functions described here. In particular, the at least one processor 202 may be realized as one or more microprocessors, controllers, microcontrollers, or state machines. Moreover, the at least one processor 202 may be implemented as a combination of computing devices, e.g., a combination of digital signal processors and microprocessors, a plurality of microprocessors, one or more microprocessors in conjunction with a digital signal processor core, or any other such configuration.

The at least one processor 202 is communicatively coupled to, and communicates with, the system memory 204. The system memory 204 is configured to store any obtained or generated data associated with creating and transmitting a cognitive employee profile, and identifying relevant employee recommendations based on the cognitive employee profile. The system memory 204 may be realized using any number of devices, components, or modules, as appropriate to the embodiment. Moreover, the employer computer system 200 could include system memory 204 integrated therein and/or a system memory 204 operatively coupled thereto, as appropriate to the particular embodiment. In practice, the system memory 204 could be realized as RAM memory, flash memory, EPROM memory, EEPROM memory, registers, a hard disk, a removable disk, or any other form of storage medium known in the art. In certain embodiments, the system memory 204 includes a hard disk, which may also be used to support functions of the employer computer system 200. The system memory 204 can be coupled to the at least one processor 202 such that the at least one processor 202 can read information from, and write information to, the system memory 204. In the alternative, the system memory 204 may be integral to the at least one processor 202. As an example, the at least one processor 202 and the system memory 204 may reside in a suitably designed application-specific integrated circuit (ASIC).

The user interface 206 may include or cooperate with various features to allow a user to interact with the employer computer system 200. Accordingly, the user interface 206 may include various human-to-machine interfaces, e.g., a keypad, keys, a keyboard, buttons, switches, knobs, a touchpad, a joystick, a pointing device, a virtual writing tablet, a touch screen, a microphone, a “virtual assistant” stored, maintained, and executed by any computing device, a voice-activated device, a text-activated device, or any device, component, or function that enables the user to select options, input information, or otherwise control the operation of the employer computer system 200. For example, the user interface 206 could be manipulated by an operator to enter a user input query for the relational database management system, as described herein.

In some embodiments, the user interface 206 may be implemented using a voice-activated and/or text-activated robot (i.e., a “bot”) that receives user input speech data, voice data, and/or text data, and which provides access to an enterprise software application platform and one or more software applications (i.e., apps) associated with, or communicatively coupled to, the enterprise software application platform. A voice-activated or text-activated “bot” may be used as an interface across all apps and the enterprise software application platform, wherein a user may populate data into, and retrieve data from, associated apps to facilitate a simplified conversational user interface (UI). Thus, a user may interact with the computer system using the voice-activated and/or text-activated “bot”, a smartwatch, a smartphone, a tablet computer, a desktop computer, or the like.

In certain embodiments, the user interface 206 may include or cooperate with various features to allow a user to interact with the employer computer system 200 via graphical elements rendered on a display element. Accordingly, the user interface 206 may initiate the creation, maintenance, and presentation of a graphical user interface (GUI). In certain embodiments, the display device implements touch-sensitive technology for purposes of interacting with the GUI. Thus, a user can manipulate the GUI by moving a cursor symbol rendered on the display device, or by physically interacting with the display device itself for recognition and interpretation, via the user interface 206.

The communication device 208 is suitably configured to communicate data between the employer computer system 200 and an employee computing device (e.g., employee computing device 104 of FIG. 1). The communication device 208 may transmit and receive communications over a wireless local area network (WLAN), the Internet, a satellite uplink/downlink, a cellular network, a broadband network, a wide area network, or the like. As described in more detail below, data received by the communication device 208 may include, without limitation: app data from software applications (i.e., apps) into which the employee has entered data; online professional networking data; online learning data; human resources data; social media data; and other data compatible with the employer computer system 200. Data provided by the communication device 208 may include, without limitation, complete or partial cognitive employee profile data, employee recommendations (e.g., action items for career, educational, and personal development), or the like.

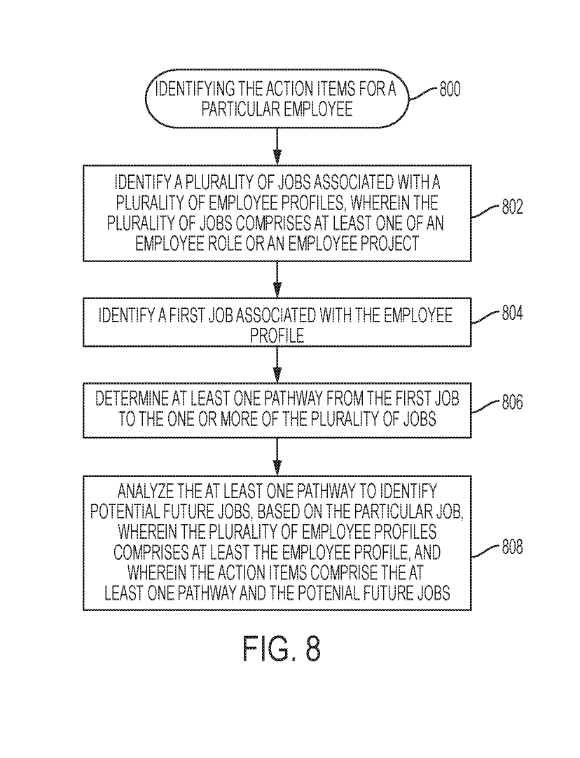

The enterprise software application platform 210 is associated with an organization and is used for relational database management and interactions between personnel of the organization. Generally, the enterprise software application platform 210 includes user-selectable, downloadable software applications (i.e., apps), social media elements for interactions within the organization, and one or more databases (e.g., human resources database, employee profile database). In certain embodiments, the enterprise software application platform 210 may be implemented by a multi-tenant database system, as described in more detail with regard to FIG. 8. The enterprise software application platform 210 is stored, maintained, and executed by the employer computer system 200.

The employer database module 212 is configured to function cooperatively with the enterprise software application platform 210 to receive, collect, or otherwise obtain employer data, or in other words, data specific to the employer or organization. Such employer data may include, without limitation, roles and projects associated with the employer or organization, whether the roles and/or projects are currently filled or available. The employer database module 212 obtains data that includes the qualifications, skills, and competencies required for each role or project.

The cognitive employee profile module 214 is configured to create and maintain an employee profile that is continuously updated in real-time, and which includes career data, educational data, and experience data for a particular employee. In some embodiments, the cognitive employee profile module 214 uses data associated with roles and projects at the employer or organization in which the employee has participated. In some embodiments, the cognitive employee profile module 214 uses any employee-entered data that the system has retrieved from software applications (i.e., apps), online learning courses or webinars, online professional networking, social media, and other data that has been entered by the employee or user into online or internet-based platforms. The cognitive employee profile module 214 may also use any employee entered data indicating completion of a course or learning experience, whether formal (e.g., formal university classes) or informal (e.g., an online course or webinar, an informal mentoring session, a public presentation that does not offer certification or formal college credit).

The employee recommendation module 216 is configured to use the employer/organizational data (e.g., from the employer database module 212) and the cognitive employee profile (e.g., from the cognitive employee profile module 214) to identify relevant career, educational, and personal development recommendations to the employee. Such recommendations may include action items or tasks for the employee to complete to achieve progression in career, education, and personal development areas. In some embodiments, the employee recommendation module 216 identifies one or more roles or projects relevant to the employee based on the employee qualifications, skills, and competencies identified in the cognitive employee profile, and the qualifications, skills, and competencies required for particular roles and/or projects at the organization. In other embodiments, the employee recommendation module 216 may identify areas for improvement, wherein the employee could add to his qualifications, skills, competencies by participating in formal or informal learning experiences (e.g., formal post-secondary classes, online learning courses or webinars, informal training at the organization, mentoring).

In practice, the enterprise software application platform 210, the employer database module 212, the cognitive employee profile module 214, and/or the employee recommendation module 216 may be implemented with (or cooperate with) the at least one processor 202 to perform at least some of the functions and operations described in more detail herein. In this regard, the enterprise software application platform 210, the employer database module 212, the cognitive employee profile module 214, and/or the employee recommendation module 216 may be realized as suitably written processing logic, application program code, or the like.

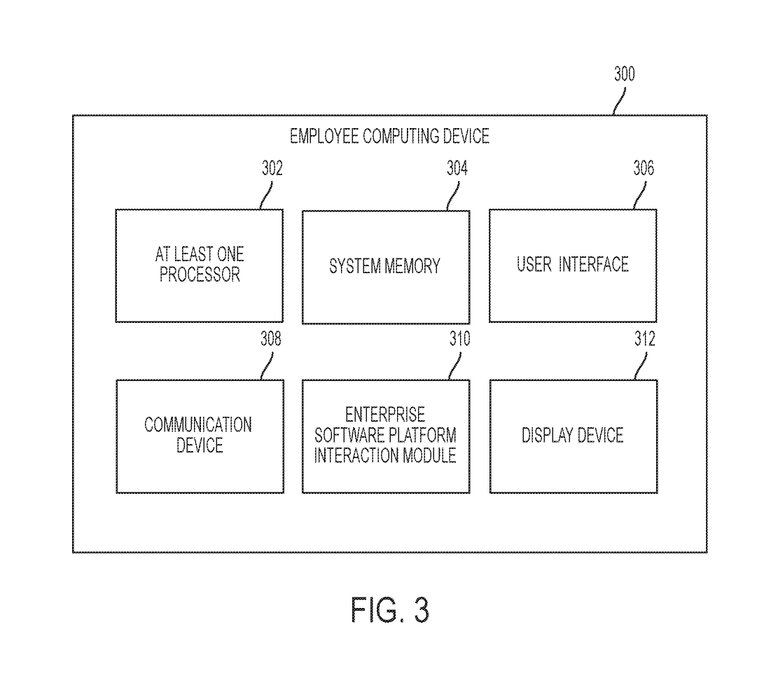

FIG. 3 is a functional block diagram of an employee computing device 300, which is suitable for use in the system shown in FIG. 1. In this regard, the employee computing device 300 shows certain elements and components of the employee computing device 104 in more detail. The illustrated embodiment of the employee computing device 300 generally includes, without limitation: at least one processor 302; system memory 304; a user interface 306; a communication device 308; an enterprise software platform interaction module 310; and a display device 312.

The at least one processor 302, the system memory 304, the user interface 306, the communication device 308, and the display device 312 are similar in configuration and function to their counterpart items described above in the context of the employer computer system 200. Accordingly, common features and operations of these elements of the employee computing device 300 will not be redundantly described here. However, in some embodiments, the type of information and the format of the data provided by the communication device 308 and/or stored in system memory 304 are different than that associated with the employee computing device 300. For example, the output of the employee computing device 300 may include a request for an updated cognitive employee profile and/or a request for recommended action items or tasks associated with the cognitive employee profile.

The enterprise software platform interaction module 310 is configured to provide an interface from which the user (i.e., the employee) provides user input to, and receives output from, an enterprise software application platform resident on an employer computer system (e.g., reference 200, FIG. 2; reference 102, FIG. 1). The enterprise software platform interaction module 310 is further configured to receive user input data for entry into: (i) one or more software applications (i.e., apps) associated with the enterprise software application platform; (ii) social media elements of the enterprise software application; (iii) one or more human resources databases; or the like. Thus, the enterprise software platform interaction module 310 may provide user input data that is transmitted (via the communication device 308) to an employer computer system for use in creating or updating a cognitive employee profile. Additionally, the enterprise software platform interaction module 310 provides an interface for user input requests for an updated cognitive employee profile and career recommendations based on the cognitive employee profile. In practice, the enterprise software platform interaction module 310 may be implemented with (or cooperate with) the at least one processor 302 to perform at least some of the functions and operations described in more detail herein. In this regard, the enterprise software platform interaction module 310 may be realized as suitably written processing logic, application program code, or the like.

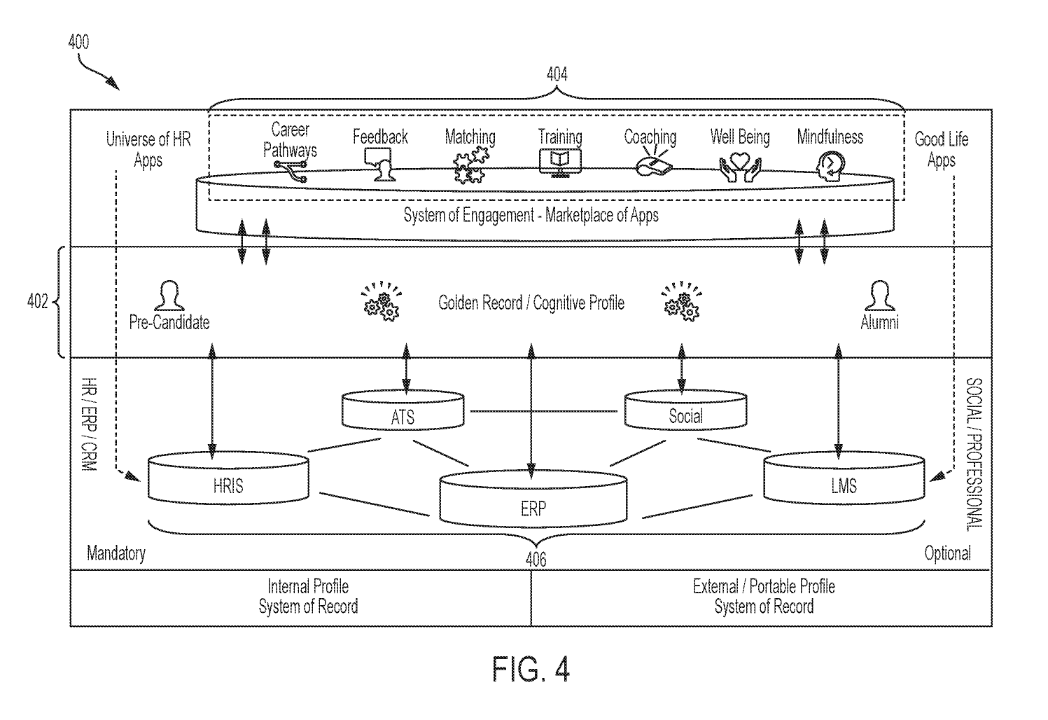

FIG. 4 is a diagram of a computer architecture 400 for producing a cognitive employee profile, in accordance with the disclosed embodiments. It should be appreciated that FIG. 4 depicts a simplified embodiment of the computer architecture 400, and that some implementations of the computer architecture 400 may include additional elements or components. As shown, the computer architecture 400 includes a cognitive employee profile 402 that is created and updated using at least the online activities of a user, and one or more databases 406 maintained by the employer (e.g., the employer computer system). In exemplary embodiments, the computer architecture 400 is implemented by the enterprise software application platform.

The online activities of the user may include any user interactions with one or more software applications (i.e., apps 404), with one or more online data sources (e.g., professional networking websites, online learning websites), with social networking elements of the enterprise software application platform, or the like. In certain embodiments, the apps 404 may include the online data sources, and the social networking elements. In some embodiments, the apps 404 include career pathway apps, career feedback apps, career matching apps, career training apps, and career coaching apps. In some embodiments, the apps 404 may include wellness apps, mindfulness apps, and other personal development apps.

The databases 406 maintained by the employer may include any social media aspects of the enterprise software application, human resources data, external systems and external data, or the like. External systems and external data may include, without limitation: external social media systems and websites like LinkedIn and Facebook; Google (e.g. Gmail, Calendar); Khan Academy, Udemy, Coursera and other online learning platforms; freelance communities and job sites like Upwork; and any other sources the user chooses to connect to their profile, including personal preferences like online media like Netflix (documentaries), Amazon (Audible online books and audio books), learning games, music and even shopping preferences as these pertain to employee reward and recognition.

As described herein, the cognitive employee profile 402 is associated with one particular employee. The cognitive employee profile 402 is created using employee interaction data obtained from the apps 404 and employment data obtained from the databases 406. The cognitive employee profile 402 is dynamically and continuously updated such that the employee has a current record that reflects a holistic view of the employee's career, education, and personal development accomplishments, interactions, and goals. Using the cognitive employee profile 402, an employer computer system (e.g., reference 102, FIG. 1; reference 200, FIG. 2) is capable of identifying areas for improvement for the employee's continued progression in career, education, and personal development, and to determine appropriate tasks for the employee to complete in order to progress in the identified areas for improvement. The employer computer system may then transmit the cognitive employee profile 402, the identified areas for improvement, and/or the tasks for completion to an employee computing device (e.g., reference 104, FIG. 1; reference 300, FIG. 3), for presentation to a user (e.g., the relevant employee).

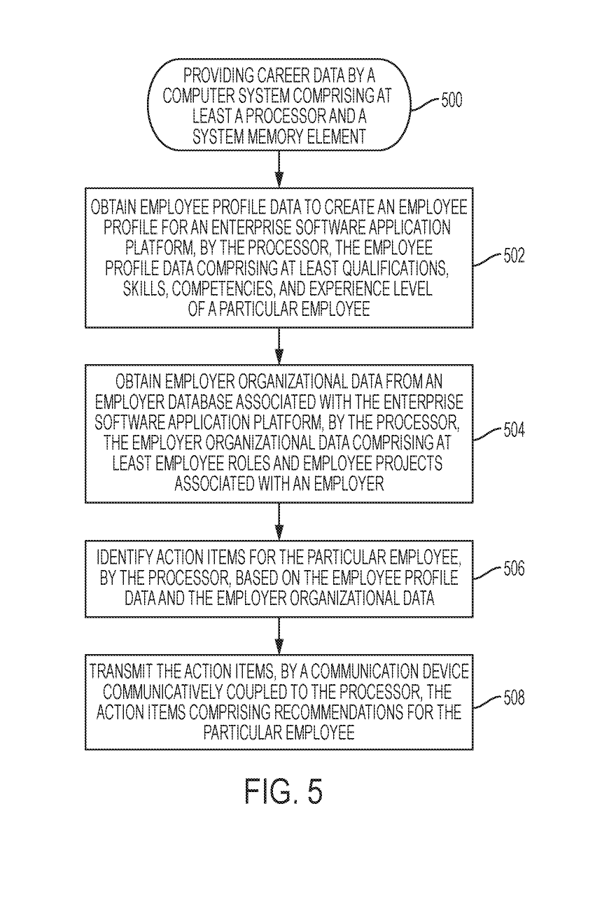

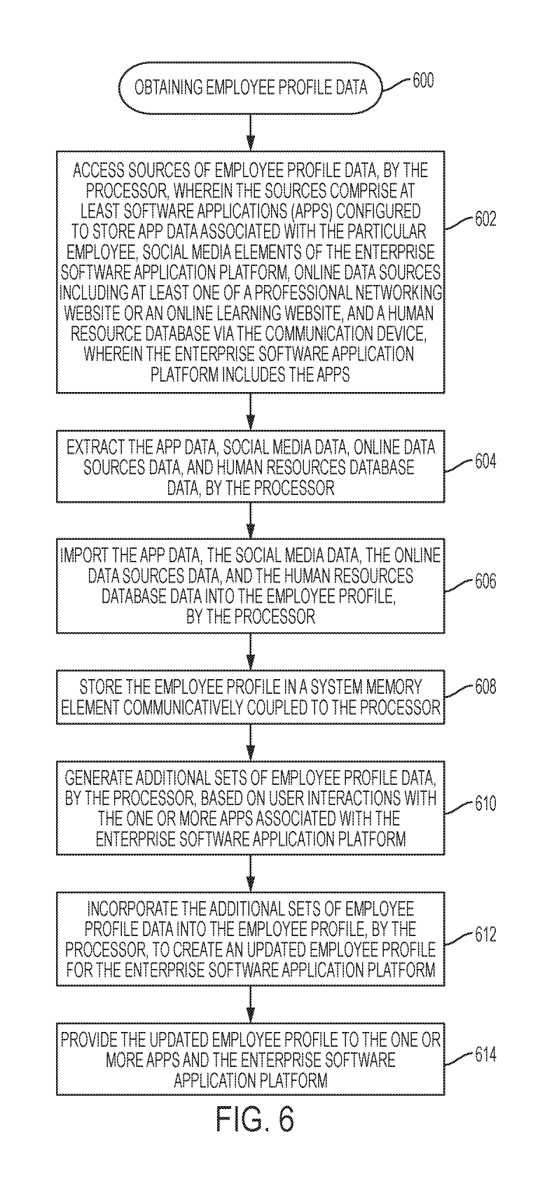

FIG. 5 is a flow chart that illustrates an embodiment of a process 500 for providing career data by a computer system comprising at least a processor and a system memory element, in accordance with the disclosed embodiments. Generally, the process 500 provides the career data using an employer computer system (e.g., reference 200, FIG. 2; reference 102, FIG. 1). First, the process 500 obtains employee profile data to create an employee profile for an enterprise software application platform, by the processor, the employee profile data comprising at least qualifications, skills, competencies, and experience level of a particular employee (step 502). One suitable methodology for obtaining employee profile data is described below with reference to FIG. 6. The employee profile may be a “cognitive” employee profile, which is continuously updated with current career, educational, and personal development information that is specific to a particular employee. Additionally, the employee profile may be an internal employee record that is specific to a particular employer, or an external employee record that is portable and includes data associated with multiple employers over the course of the employee's career.

The process 500 also obtains employer organizational data from an employer database associated with the enterprise software application platform, by the processor, the employer organizational data comprising at least employee roles and employee projects associated with an employer (step 504). The employer organizational data includes employee roles and employee projects associated with a particular employer, and the qualifications, skills, and competencies required for an employee to qualify to fill a particular role or project within the organization.

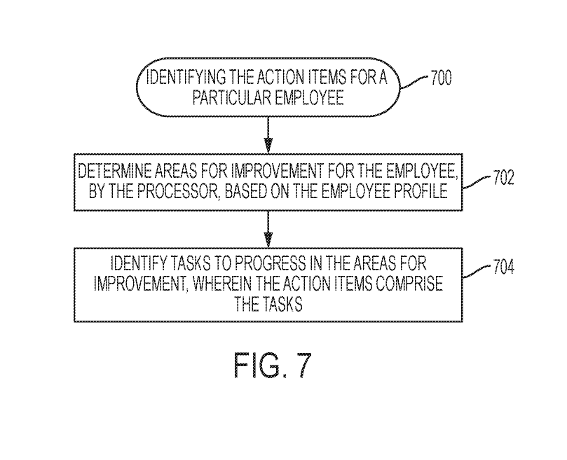

Next, the process 500 identifies action items for the particular employee, by the processor, based on the employee profile data and the employer organizational data (step 506). One suitable methodology for identifying action items for the particular employee is described below with reference to FIG. 7. Another suitable methodology for identifying action items for the particular employee is described below with reference to FIG. 8. Here, the process 500 identifies areas for improvement in the employee profile, based on available opportunities (e.g., roles, projects) at the employer that correlate to the skills, qualifications, and competencies included in the employee profile. In some embodiments, the process 500 also identifies other areas for improvement in the employee profile, such as formal and informal learning opportunities, mentorship opportunities, or the like. Here the process 500 identifies the areas for improvement, and the action items that the employee may complete to improve in the identified areas.

The process 500 then transmits the action items, by a communication device communicatively coupled to the processor, the action items comprising recommendations for the particular employee (step 508). The process 500 generally uses an employer computer system to generate the action items, and to transmit the action items to an employee computing device for viewing and interaction by a user (i.e., the employee specific to the cognitive profile). In certain embodiments, the process 500 provides and presents the action items or recommendations based on a permission level of a user. Here, the process 500 receives a user input request to present the employee profile, by a user interface communicatively coupled to the processor; determines a permission level of a user submitting the user input request; and when the user is associated with a required level of permission to obtain access to the employee profile, presenting the employee profile, by the display device communicatively coupled to the processor.

FIG. 6 is a flow chart that illustrates an embodiment of a process 600 for obtaining employee profile data, in accordance with the disclosed embodiments. It should be appreciated that the process 600 described in FIG. 6 represents one embodiment of step 502 described above in the discussion of FIG. 5, including additional detail.

The process 600 accesses sources of employee profile data, by the processor (step 602). The sources of employee profile data may include one or more of the following, without limitation: (1) software applications (i.e., apps) configured to store app data associated with the particular employee, wherein the enterprise software application platform includes the apps or wherein the enterprise software application platform communicates with external apps; (2) social media elements of the enterprise software application platform, such as graphical chat elements, graphical posting elements, or the like; (3) online data sources including at least one of a professional networking website or an online learning website; and (4) a human resources database that includes a current job description, recruiting data, interview questions, candidate responses to the interview questions, employee reviews, employee goals, employee feedback, and mentoring data, or the like, and which is maintained by the employer or organization.

The process 600 then extracts the app data, social media data, online data sources data, and/or human resources database data, by the processor (step 604), and imports the app data, the social media data, the online data sources data, and/or the human resources database data into the employee profile, by the processor (step 606). In this way, the process 600 creates or updates the employee profile using up-to-date information that has been entered by the user or information about the user or the user's online activities. The process 600 then stores the employee profile in a system memory element communicatively coupled to the processor (step 608).

The process 600 also generates additional sets of employee profile data, by the processor, based on user interactions with the one or more apps associated with the enterprise software application platform (step 610). Two user interactions: (1) user actions performed within one or more apps, and (2) user-entered employee profile data, which includes any career data or employee profile data entered by the user into the computer system. User actions performed within the one or more apps may include, without limitation: user completion of a virtual or online course, user updates to a professional networking app (e.g., user updates to a LinkedIn profile), user participation in an online webinar, any user interaction with an online learning website, or the like. User-entered employee profile data may include any new or updated information associated with employee profile data, which may include, without limitation: qualifications, skills, competencies, and experience level of a particular employee. User-entered employee profile data may also include new or updated information for employee roles, employee projects, employers, dates of employment, employee responsibilities, resume data, educational data (e.g., formal education, informal education, continuing education, online learning), or the like.

The process 600 then incorporates the additional sets of employee data (generated in step 610) into the employee profile, by the processor, to create an updated employee profile for the enterprise software application platform (step 612).

In steps 602-604, the process 600 obtains employee profile data by retrieving data from sources of employee profile data. Here, in step 610, the process 600 generates additional employee profile data based on user interactions that create more employee profile data. The process 600 uses the obtained and generated employee profile data to update the employee profile. In certain embodiments, the process 600 continuously updates the employee profile by continuously obtaining employee profile data from sources of employee profile data, continuously generating additional sets of employee profile data, continuously incorporating the obtained and generated sets of employee profile data into the employee profile to continuously update a cognitive employee profile for the enterprise software application platform. Thus, the cognitive employee profile is continuously revised and improved with accurate and up-to-date information for the employee. The process 600 then provides the updated employee profile (or the cognitive employee profile that is continuously updated) to the one or more apps and the enterprise software application platform (step 614).

FIG. 7 is a flow chart that illustrates an embodiment of a process 700 for identifying the action items for a particular employee. It should be appreciated that the process 700 described in FIG. 7 represents one embodiment of step 506 described above in the discussion of FIG. 5, including additional detail. First, the process 700 determines areas for improvement for the employee, by the processor, based on the employee profile (step 702). Areas for improvement may be any aspect of the employee profile, which may include career, education, or personal development. Career areas for improvement may include employee roles or employee projects at a particular organization. Educational areas for improvement may include classes or experiences required to acquire skills, competencies, or qualifications associated with a particular employee role or a particular employee project. Personal development areas for improvement may include mentoring, meetings, or other experiences associated with skills, competencies, or qualifications associated with a particular employee role or a particular employee project.

The process 700 then identifies tasks to progress in the areas for improvement, wherein the action items comprise the tasks (step 704). Such tasks may include applying for a new project or role at the organization or employer; attending formal or informal educational experiences (e.g., formal university classes, formal online classes, informal lectures, informal meetings); and/or meeting with a mentor or joining a professional organization.

In some embodiments, the employee profile comprises a cognitive employee profile that is continuously and dynamically updated by the process 700, in order to generate updated employee recommendations. Here, the process 700 obtains, by the processor, updated data indicating completion of one or more of the tasks by the particular employee; incorporates the updated data into the employee profile data stored in the system memory element, by the processor, to create updated employee profile data; identifies a second set of action items for the particular employee, by the processor, based on the updated employee profile data; and transmits the second set of action items, by the communication device, the second set of action items comprising updated recommendations for the particular employee.

FIG. 8 is a flow chart that illustrates an embodiment of a process 800 for identifying the action items for a particular employee. It should be appreciated that the process 800 described in FIG. 8 represents one embodiment of step 506 described above in the discussion of FIG. 5, including additional detail. First, the process 800 identifies a plurality of jobs associated with a plurality of employee profiles, wherein the plurality of jobs comprises at least one of an employee role or an employee project (step 802). The process 800 also identifies a first job associated with the employee profile (step 804).

The process 800 then determines at least one pathway from the first job to the one or more of the plurality of jobs (step 806). Here, the process 800 uses employee profiles that include job profiles, wherein the job profiles have been created by the experience of those people (i.e., employees) that have held the job. The process 800 analyzes the plurality of employee profiles to identify jobs, and to determine pathways or connections between the identified jobs. Each of the pathways or connections is a procedure or course of action that may be followed during an employee's career progression, from a first job to a second job.

The process 800 analyzes the at least one pathway to identify potential future jobs, based on the particular job, wherein the plurality of employee profiles comprises at least the employee profile, and wherein the action items comprise the at least one pathway and the potential future jobs (step 808). Once potential future jobs are identified, based on identified career progression from a first job to a second job, a second job to a third job, a third job to a fourth job, and so on, then the process 800 can provide recommendations to the user for potential future jobs for the employee to pursue, or tasks/action items for the employee to complete to move forward in a career progression and to enable the employee to become qualified for the next role or project in a career progression.

The various tasks performed in connection with processes 500-800 may be performed by software, hardware, firmware, or any combination thereof. For illustrative purposes, the preceding descriptions of processes 500-800 may refer to elements mentioned above in connection with FIGS. 1-4. In practice, portions of processes 500-800 may be performed by different elements of the described system. It should be appreciated that processes 500-800 may include any number of additional or alternative tasks, the tasks shown in FIGS. 5-8 need not be performed in the illustrated order, and processes 500-800 may be incorporated into a more comprehensive procedure or process having additional functionality not described in detail herein. Moreover, one or more of the tasks shown in FIGS. 5-8 could be omitted from an embodiment of the processes 500-800 as long as the intended overall functionality remains intact.

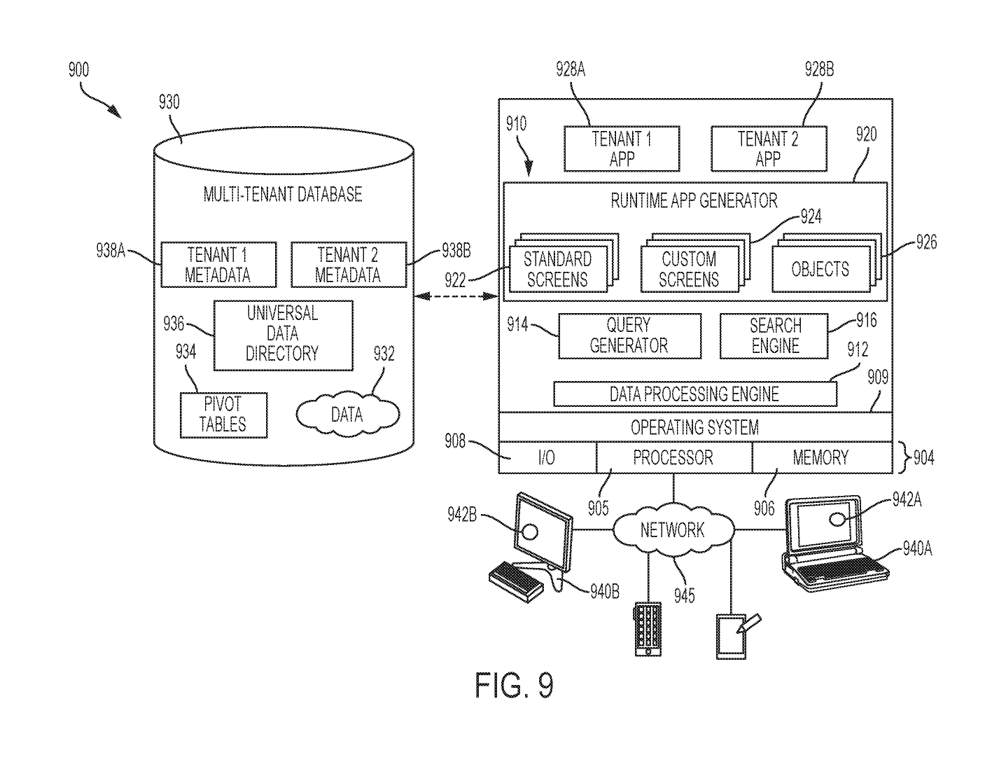

FIG. 9 is a conceptual block diagram of a multi-tenant system in accordance with the disclosed embodiments. The multi-tenant system 900 may be used to in conjunction with the relational database management system and/or enterprise software applications described previously. Platform as a Service (PaaS) is the foundation of the multi-tenant architecture. At the heart, this PaaS is a relational database management system. All of the core mechanisms in a relational database management system (RDBMS) (e.g., a system catalog, caching mechanisms, query optimizer, and application development features) are built to support multi-tenant applications and to be run directly on top of a specifically tuned host operating system and raw hardware. The runtime engine has the intelligence to access the metadata and transactional data and perform the application functionality that can scale.

The multi-tenant system 900 of FIG. 9 includes a server 902 that dynamically creates and supports virtual applications 928 based upon data 932 from a common database 930 that is shared between multiple tenants, alternatively referred to herein as a multi-tenant database. Data and services generated by the virtual applications 928 are provided via a network 945 to any number of client devices 940, as desired. Each virtual application 928 is suitably generated at run-time (or on-demand) using a common application platform 910 that securely provides access to the data 932 in the database 930 for each of the various tenants subscribing to the multi-tenant system 900. In accordance with one non-limiting example, the multi-tenant system 900 is implemented in the form of an on-demand multi-tenant customer relationship management (CRM) system that can support any number of authenticated users of multiple tenants.

As used herein, a “tenant” or an “organization” should be understood as referring to a group of one or more users that shares access to common subset of the data within the multi-tenant database 930. In this regard, each tenant includes one or more users associated with, assigned to, or otherwise belonging to that respective tenant. To put it another way, each respective user within the multi-tenant system 900 is associated with, assigned to, or otherwise belongs to a particular tenant of the plurality of tenants supported by the multi-tenant system 900. Tenants may represent customers, customer departments, business or legal organizations, and/or any other entities that maintain data for particular sets of users within the multi-tenant system 900 (i.e., in the multi-tenant database 930). For example, the application server 902 may be associated with one or more tenants supported by the multi-tenant system 900. Although multiple tenants may share access to the server 902 and the database 930, the particular data and services provided from the server 902 to each tenant can be securely isolated from those provided to other tenants (e.g., by restricting other tenants from accessing a particular tenant's data using that tenant's unique organization identifier as a filtering criterion). The multi-tenant architecture therefore allows different sets of users to share functionality and hardware resources without necessarily sharing any of the data 932 belonging to or otherwise associated with other tenants.

The multi-tenant database 930 is any sort of repository or other data storage system capable of storing and managing the data 932 associated with any number of tenants. The database 930 may be implemented using any type of conventional database server hardware. In various embodiments, the database 930 shares processing hardware 904 with the server 902. In other embodiments, the database 930 is implemented using separate physical and/or virtual database server hardware that communicates with the server 902 to perform the various functions described herein. In an exemplary embodiment, the database 930 includes a database management system or other equivalent software capable of determining an optimal query plan for retrieving and providing a particular subset of the data 932 to an instance of virtual application 928 in response to a query initiated or otherwise provided by a virtual application 928. The multi-tenant database 930 may alternatively be referred to herein as an on-demand database, in that the multi-tenant database 930 provides (or is available to provide) data at run-time to on-demand virtual applications 928 generated by the application platform 910.

In practice, the data 932 may be organized and formatted in any manner to support the application platform 910. In various embodiments, the data 932 is suitably organized into a relatively small number of large data tables to maintain a semi-amorphous “heap”-type format. The data 932 can then be organized as needed for a particular virtual application 928. In various embodiments, conventional data relationships are established using any number of pivot tables 934 that establish indexing, uniqueness, relationships between entities, and/or other aspects of conventional database organization as desired. Further data manipulation and report formatting is generally performed at run-time using a variety of metadata constructs. Metadata within a universal data directory (UDD) 936, for example, can be used to describe any number of forms, reports, workflows, user access privileges, business logic and other constructs that are common to multiple tenants. Tenant-specific formatting, functions and other constructs may be maintained as tenant-specific metadata 938 for each tenant, as desired. Rather than forcing the data 932 into an inflexible global structure that is common to all tenants and applications, the database 930 is organized to be relatively amorphous, with the pivot tables 934 and the metadata 938 providing additional structure on an as-needed basis. To that end, the application platform 910 suitably uses the pivot tables 934 and/or the metadata 938 to generate “virtual” components of the virtual applications 928 to logically obtain, process, and present the relatively amorphous data 932 from the database 930.

The server 902 is implemented using one or more actual and/or virtual computing systems that collectively provide the dynamic application platform 910 for generating the virtual applications 928. For example, the server 902 may be implemented using a cluster of actual and/or virtual servers operating in conjunction with each other, typically in association with conventional network communications, cluster management, load balancing and other features as appropriate. The server 902 operates with any sort of conventional processing hardware 904, such as a processor 905, memory 906, input/output features 908 and the like. The input/output features 908 generally represent the interface(s) to networks (e.g., to the network 945, or any other local area, wide area or other network), mass storage, display devices, data entry devices and/or the like. The processor 905 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 906 represents any non-transitory short or long term storage or other computer-readable media capable of storing programming instructions for execution on the processor 905, including any sort of random access memory (RAM), read only memory (ROM), flash memory, magnetic or optical mass storage, and/or the like. The computer-executable programming instructions, when read and executed by the server 902 and/or processor 905, cause the server 902 and/or processor 905 to create, generate, or otherwise facilitate the application platform 910 and/or virtual applications 928 and perform one or more additional tasks, operations, functions, and/or processes described herein. It should be noted that the memory 906 represents one suitable implementation of such computer-readable media, and alternatively or additionally, the server 902 could receive and cooperate with external computer-readable media that is realized as a portable or mobile component or application platform, e.g., a portable hard drive, a USB flash drive, an optical disc, or the like.

The application platform 910 is any sort of software application or other data processing engine that generates the virtual applications 928 that provide data and/or services to the client devices 940. In a typical embodiment, the application platform 910 gains access to processing resources, communications interfaces and other features of the processing hardware 904 using any sort of conventional or proprietary operating system 909. The virtual applications 928 are typically generated at run-time in response to input received from the client devices 940. For the illustrated embodiment, the application platform 910 includes a bulk data processing engine 912, a query generator 914, a search engine 916 that provides text indexing and other search functionality, and a runtime application generator 920. Each of these features may be implemented as a separate process or other module, and many equivalent embodiments could include different and/or additional features, components or other modules as desired.

The runtime application generator 920 dynamically builds and executes the virtual applications 928 in response to specific requests received from the client devices 940. The virtual applications 928 are typically constructed in accordance with the tenant-specific metadata 938, which describes the particular tables, reports, interfaces and/or other features of the particular application 928. In various embodiments, each virtual application 928 generates dynamic web content that can be served to a browser or other client program 942 associated with its client device 940, as appropriate.

The runtime application generator 920 suitably interacts with the query generator 914 to efficiently obtain multi-tenant data 932 from the database 930 as needed in response to input queries initiated or otherwise provided by users of the client devices 940. In a typical embodiment, the query generator 914 considers the identity of the user requesting a particular function (along with the user's associated tenant), and then builds and executes queries to the database 930 using system-wide metadata 936, tenant specific metadata 938, pivot tables 934, and/or any other available resources. The query generator 914 in this example therefore maintains security of the common database 930 by ensuring that queries are consistent with access privileges granted to the user and/or tenant that initiated the request. In this manner, the query generator 914 suitably obtains requested subsets of data 932 accessible to a user and/or tenant from the database 930 as needed to populate the tables, reports or other features of the particular virtual application 928 for that user and/or tenant.

Still referring to FIG. 9, the data processing engine 912 performs bulk processing operations on the data 932 such as uploads or downloads, updates, online transaction processing, and/or the like. In many embodiments, less urgent bulk processing of the data 932 can be scheduled to occur as processing resources become available, thereby giving priority to more urgent data processing by the query generator 914, the search engine 916, the virtual applications 928, etc.

In exemplary embodiments, the application platform 910 is utilized to create and/or generate data-driven virtual applications 928 for the tenants that they support. Such virtual applications 928 may make use of interface features such as custom (or tenant-specific) screens 924, standard (or universal) screens 922 or the like. Any number of custom and/or standard objects 926 may also be available for integration into tenant-developed virtual applications 928. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system. For example, a virtual CRM application may utilize standard objects 926 such as “account” objects, “opportunity” objects, “contact” objects, or the like. The data 932 associated with each virtual application 928 is provided to the database 930, as appropriate, and stored until it is requested or is otherwise needed, along with the metadata 938 that describes the particular features (e.g., reports, tables, functions, objects, fields, formulas, code, etc.) of that particular virtual application 928. For example, a virtual application 928 may include a number of objects 926 accessible to a tenant, wherein for each object 926 accessible to the tenant, information pertaining to its object type along with values for various fields associated with that respective object type are maintained as metadata 938 in the database 930. In this regard, the object type defines the structure (e.g., the formatting, functions and other constructs) of each respective object 926 and the various fields associated therewith.

Still referring to FIG. 9, the data and services provided by the server 902 can be retrieved using any sort of personal computer, mobile telephone, tablet or other network-enabled client device 940 on the network 945. In an exemplary embodiment, the client device 940 includes a display device, such as a monitor, screen, or another conventional electronic display capable of graphically presenting data and/or information retrieved from the multi-tenant database 930. Typically, the user operates a conventional browser application or other client program 942 executed by the client device 940 to contact the server 902 via the network 945 using a networking protocol, such as the hypertext transport protocol (HTTP) or the like. The user typically authenticates his or her identity to the server 902 to obtain a session identifier (“SessionID”) that identifies the user in subsequent communications with the server 902. When the identified user requests access to a virtual application 928, the runtime application generator 920 suitably creates the application at run time based upon the metadata 938, as appropriate. As noted above, the virtual application 928 may contain Java, ActiveX, or other content that can be presented using conventional client software running on the client device 940; other embodiments may simply provide dynamic web or other content that can be presented and viewed by the user, as desired.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The following description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, although the schematics shown in FIGS. 2-3 depict exemplary arrangements of elements, additional intervening elements, devices, features, or components may be present in an embodiment of the depicted subject matter.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for providing career data by a computer system comprising at least a processor and a system memory element, the method comprising:
obtaining employee profile data to create an employee profile for an enterprise software application platform, by the processor, wherein the employee profile data comprises at least qualifications, skills, competencies, and experience level of a particular employee, and wherein the employee profile is shared by one or more applications (apps) associated with the enterprise software application platform;
obtaining employer organizational data from an employer database associated with the enterprise software application platform, by the processor, the employer organizational data comprising at least employee roles and employee projects associated with an employer;
identifying action items for the particular employee, by the processor, based on the employee profile data and the employer organizational data; and
transmitting the action items, by a communication device communicatively coupled to the processor, the action items comprising recommendations for the particular employee.

2. The method of claim 1, further comprising:
generating additional sets of employee profile data, by the processor, based on user interactions with the one or more apps associated with the enterprise software application platform;
incorporating the additional sets of employee profile data into the employee profile, by the processor, to create an updated employee profile for the enterprise software application platform; and
providing the updated employee profile to the one or more apps and the enterprise software application platform.

3. The method of claim 2, further comprising:
continuously generating the additional sets of employee profile data;
continuously incorporating the additional sets of employee profile data into the employee profile, to continuously update a cognitive employee profile for the enterprise software application platform, wherein the cognitive employee profile comprises the updated employee profile;
continuously providing the cognitive employee profile to the one or more apps and the enterprise software application platform.

4. The method of claim 2, further comprising:
receiving user input selections of a subset of the employee profile data and one of the one or more apps, wherein the user interactions with the one or more apps further comprise the user input selections; and
denying access to the subset of the employee profile data by the one of the one or more apps, based on the user input selections.

5. The method of claim 1, further comprising:
identifying a plurality of jobs associated with a plurality of employee profiles, wherein the plurality of jobs comprises at least one of an employee role or an employee project;
identifying a first job associated with the employee profile;
determining at least one pathway from the first job to one or more of the plurality of jobs; and
analyzing the at least one pathway to identify potential future jobs, based on the particular job, wherein the plurality of employee profiles comprises at least the employee profile;
wherein the actions items comprise the at least one pathway and the potential future jobs.

6. The method of claim 1, wherein obtaining the employee profile data further comprises:
accessing software applications (apps) configured to store app data associated with the particular employee, by the processor, wherein the enterprise software application platform includes the apps;
extracting the app data from the apps, by the processor;
importing the app data into the employee profile, by the processor; and
storing the employee profile in the system memory element;
wherein the employee profile data further comprises the app data.

7. The method of claim 1, wherein obtaining the employee profile data further comprises:
accessing social media elements of the enterprise software application platform, by the processor;
extracting social media data associated with the particular employee, by the processor;
importing the extracted social media data into the employee profile, by the processor; and
storing the employee profile in the system memory element;
wherein the employee profile data further comprises the social media data.

8. The method of claim 1, wherein obtaining the employee profile data further comprises:
accessing online data sources including at least one of a professional networking website or an online learning websites, by the processor;
extracting professional networking data and online learning data from the online data sources, by the processor;
importing the professional networking data and the online learning data into the employee profile, by the processor; and
storing the employee profile in the system memory element;
wherein the employee profile data further comprises the professional networking data and the online learning data.

9. The method of claim 1, wherein obtaining the employee profile data further comprises:
accessing a human resources database via the communication device;
extracting human resources data comprising one or more of a current job description, recruiting data, interview questions, candidate responses to the interview questions, employee reviews, employee goals, employee feedback, experiential learning, formal learning, and mentoring data;
importing the human resources data into the employee profile, by the processor; and
storing the employee profile in the system memory element;
wherein the employee profile data further comprises the human resources data.

10. The method of claim 1, further comprising:
receiving a user input request to present the employee profile, by a user interface communicatively coupled to the processor;
determining a permission level of a user submitting the user input request; and
when the user is associated with a required level of permission to obtain access to the employee profile, presenting the employee profile, by the display device communicatively coupled to the processor.

11. The method of claim 1, wherein identifying the action items further comprises:
determining areas for improvement for the employee, by the processor, based on the employee profile; and
identifying tasks to progress in the areas for improvement, wherein the action items comprise the tasks.

12. The method of claim 11, further comprising:
obtaining, by the processor, updated data indicating completion of one or more of the tasks by the particular employee;
incorporating the updated data into the employee profile data stored in the system memory element, by the processor, to create updated employee profile data;
identifying a second set of action items for the particular employee, by the processor, based on the updated employee profile data; and
transmitting the second set of action items, by the communication device, the second set of action items comprising updated recommendations for the particular employee.

13. A computer system, comprising:
a system memory element;
a communication device configured to establish a communication connection to a second computer system and to transmit career data for a particular employee; and
at least one processor communicatively coupled to the system memory element and the communication device, the at least one processor configured to:
obtain employee profile data to create an employee profile for an enterprise software application platform, by the processor, wherein the employee profile data comprises at least qualifications, skills, competencies, and experience level of a particular employee, and wherein the employee profile is shared by one or more applications (apps) associated with the enterprise software application platform;
obtain employer organizational data from an employer database associated with the enterprise software application platform, by the processor, the employer organizational data comprising at least employee roles and employee projects associated with an employer;
identify action items for the particular employee, by the processor, based on the employee profile data and the employer organizational data; and
transmit the action items, by a communication device communicatively coupled to the processor, the action items comprising recommendations for the particular employee.

14. The computer system of claim 13, wherein the at least one processor is further configured to obtain the employee profile data, by:
accessing the one or more apps configured to store app data associated with the particular employee, by the processor, wherein the enterprise software application platform includes the apps;
extracting the app data from the apps, by the processor;
importing the app data into the employee profile, by the processor; and
storing the employee profile in the system memory element;
wherein the employee profile data further comprises the app data.

15. The computer system of claim 13, wherein the at least one processor is further configured to obtain the employee profile data, by:
accessing social media elements of the enterprise software application platform, by the processor;
extracting social media data associated with the particular employee, by the processor;
importing the extracted social media data into the employee profile, by the processor; and
storing the employee profile in the system memory element;
wherein the employee profile data further comprises the social media data.

16. The computer system of claim 13, wherein the at least one processor is further configured to obtain the employee profile data, by:
accessing online data sources including at least one of a professional networking website or an online learning websites, by the processor;
extracting professional networking data and online learning data from the online data sources, by the processor;
importing the professional networking data and the online learning data into the employee profile, by the processor; and
storing the employee profile in the system memory element;
wherein the employee profile data further comprises the professional networking data and the online learning data.

17. The computer system of claim 13, wherein the at least one processor is further configured to obtain the employee profile data, by:
accessing a human resources database via the communication device;
extracting human resources data comprising one or more of a current job description, recruiting data, interview questions, candidate responses to the interview questions, employee reviews, employee goals, employee feedback, and mentoring data;
importing the human resources data into the employee profile, by the processor; and
storing the employee profile in the system memory element;
wherein the employee profile data further comprises the human resources data.

18. The computer system of claim 13, further comprising a user interface communicatively coupled to the at least one processor, the user interface configured to receive a user input request to present the employee profile;
wherein the at least one processor is further configured to:
determine a permission level of a user submitting the user input request; and
when the user is associated with a required level of permission to obtain access to the employee profile, presenting the employee profile, by a display device communicatively coupled to the processor.

19. The computer system of claim 13, wherein the at least one processor is further configured to identify the action items by:
determining areas for improvement for the employee, by the processor, based on the employee profile; and
identifying tasks to progress in the areas for improvement, wherein the action items comprise the tasks.

20. The computer system of claim 19, wherein the at least one processor is further configured to:
obtain updated data indicating completion of one or more of the tasks by the particular employee;
incorporate the updated data into the employee profile data stored in the system memory element, to create updated employee profile data;
identify a second set of action items for the particular employee, based on the updated employee profile data; and
transmit the second set of action items, via the communication device, the second set of action items comprising updated recommendations for the particular employee.
